(19) United States
(12) Patent Application Publication
(10) Pub. No.: US 2007/0030408 A1
(43) Pub. Date: Feb. 8, 2007

(54) LIQUID CRYSTAL DISPLAY PANEL, THIN FILM TRANSISTOR ARRAY SUBSTRATE AND DETECTION METHODS THEREFOR

(76) Inventors: Kuang-Hsiang Lin, Taoyuan County (TW); Yuan-Hao Chang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,531

(22) Filed: Aug. 8, 2005

(51) Int. Cl. G02F 1/1333

(52) U.S. Cl. 349/40

(57) ABSTRACT

A thin film transistor (TFT) array substrate including a substrate, pixel units, scan and data lines, inner anti-static rings, first and second thin film transistors is provided. The pixel units are arranged on a display region of the substrate, and the scan and data lines are arranged on the substrate. Each pixel unit is controlled by the corresponding scan and data line. The inner anti-static rings, the first and second TFTs are arranged on a peripheral circuit region of the substrate around the display region. The gate and source of each first TFT are connected to one part of the inner anti-static ring, and the drain of each first TFT is connected to the scan line respectively. The gate and source of each second TFT are connected to the other part of the inner anti-static ring, and the drain of each second TFT is connected to the data line respectively.

### BACKGROUND OF THE INVENTION

1. Field of the Invention

The present invention generally relates to a display panel, an active device array substrate and detection methods thereof. More particularly, the present invention relates to a liquid crystal display panel, a thin film transistor array substrate and detection methods thereof.

2. Description of Related Art

Since the demand of displays is drastically increasing, the industry has devoted full efforts to develop display devices and their associated products. Among these display devices, a cathode ray tube (CRT) had occupied the market for a long time because it had excellent display quality and technology maturity. However, the larger power consumption and the higher radiation features of the CRT contradict to the green environment concept. In addition, to further minimize the occupied space of a CRT is limited. As a result, the CRT can not meet the market trend of a lightweight, thin, short, compact, appealing and low-power consumption product. Accordingly, a thin film transistor liquid crystal display (TFT-LCD) having the features of high image quality, optimal space efficiency and low power consumption has become a mainstream in the market.

The TFT-LCD module mainly comprises a liquid crystal display panel and a backlight module. The liquid crystal display panel generally comprises a thin film transistor array substrate, a color filter substrate and a liquid crystal layer sandwiched between them. The backlight module is to providing a surface light source for the liquid crystal display panel, to achieve the display effect.

The thin film transistor array substrate comprises a display region and a peripheral circuit region. A plurality of pixel units arranged in an array are formed on the display region. Each pixel unit comprises a thin film transistor and a pixel electrode connected thereto. Besides, a plurality of scan lines and data lines are arranged on the peripheral circuit region and the display region. The thin film transistor of each pixel unit is controlled by the corresponding scan line and data line.

After the fabrication process of the thin film transistor array substrate, an electrical test is usually performed on the pixel unit of the thin film transistor array substrate, to determine whether the pixel unit is normal or not. If the pixel unit is abnormal, it needs to repair the abnormal device (such as thin film transistor or pixel electrode . . . etc.) or circuit. However, a detection circuit should be formed on the peripheral circuit region of the thin film transistor array substrate in order to perform the electrical test. It should be noted that the detection circuit is complex, and the layout region of the panel would narrow down because of the detection circuit. Besides, after the electrical test is performed, the detection circuit would be disabled by laser cutting technology, to avoid affecting the display quality of the liquid crystal display panel.

Furthermore, the external factors such as manual transportation or changes in the environment may lead to the static charges accumulation in the liquid crystal display panel. When the static charges exceed a definite amount, an electrostatic discharge may occur and this would damage the lines or the thin film transistor on the thin film transistor array substrate. Therefore, an electrostatic discharge (ESD) protection circuit is formed on the peripheral circuit region, to avoid the damages resulted from electrostatic discharge.

However, to achieve the above mentioned electrical test and ESD protection functions, the detection circuit and the ESD protection circuit should be fabricated on the peripheral circuit region of the thin film transistor array substrate simultaneously. So, it will make the layout of the peripheral circuit region more complex and the space for the layout may not be enough. And this doesn't help simplify the fabrication process and promote the productivity efficiency.

### SUMMARY OF THE INVENTION

Accordingly, the present invention is directed to a thin film transistor array substrate with a simpler layout.

The present invention is also directed to providing a liquid crystal display panel with a simpler detection circuit.

The present invention is directed to providing a detection method for detecting whether a short circuit occurs between the lines of the thin film transistor array substrate or not.

The present invention is also directed to providing a detection method for detecting whether the display of the liquid crystal display panel is normal or not.

To achieve the above and other objects, the present invention provides a thin film transistor array substrate comprising a substrate, a plurality of pixel units, a plurality of scan lines, a plurality of data lines, a plurality of inner anti-static rings, a plurality of first and second thin film transistors. The substrate comprises a display region and a peripheral circuit region around the display region. The pixel units are arranged on the display region. The scan lines and data lines are arranged on the substrate, and the pixel units are controlled by the scan lines and data lines. The inner anti-static rings are arranged on the peripheral circuit region, and the first and second thin film transistors are also arranged on the peripheral circuit region. Each first thin film transistor comprises a gate, a source and a drain. The gates and the sources are connected to one part of the inner anti-static rings, and the drains are connected to the scan lines respectively. Each second thin film transistor comprises a gate, a source and a drain. The gates and the sources are connected to the other part of the inner anti-static rings, and the drains are connected to the data lines respectively.

According to an embodiment of the present invention, the thin film transistor array substrate may further comprise a plurality of detection pads arranged on the peripheral circuit region. One end of each inner anti-static ring is connected to one of the detection pad.

According to an embodiment of the present invention, each pixel unit comprises an active device and a pixel electrode. The active device is connected to one of the scan lines and data lines, and the pixel electrode is connected to the active device.

According to an embodiment of the present invention, the thin film transistor array substrate may further comprise a plurality of common lines and a detection trace connected to one end of the common lines. The common lines are arranged on the substrate and the detection trace is arranged on the peripheral circuit region.

To achieve the above and other objects, the present invention provides a liquid crystal display panel comprising a thin film transistor array substrate, a color filter substrate and a liquid crystal layer sandwiched between them. The thin film transistor array substrate comprises a substrate, a plurality of pixel units, a plurality of scan lines, a plurality of data lines, a plurality of inner anti-static rings, a plurality of first and second thin film transistors. The substrate comprises a display region and a peripheral circuit region around the display region. The pixel units are arranged on the display region. The scan lines and data lines are arranged on the substrate, and the pixel units are controlled by the scan lines and data lines. The inner anti-static rings are arranged on the peripheral circuit region, and the first and second thin film transistors are also arranged on the peripheral circuit region. Each first thin film transistor comprises a gate, a source and a drain. The gates and the sources are connected to one part of the inner anti-static rings, and the drains are connected to the scan lines respectively. Each second thin film transistor comprises a gate, a source and a drain. The gates and the sources are connected to the other part of the inner anti-static rings, and the drains are connected to the data lines respectively.

According to an embodiment of the present invention, the thin film transistor array substrate may further comprise a plurality of detection pads arranged on the peripheral circuit region. One end of each inner anti-static ring is connected to the corresponding detection pad.

According to an embodiment of the present invention, each pixel unit comprises an active device and a pixel electrode. The active device is connected to one of the scan lines and data lines, and the pixel electrode is connected to the active device.

According to an embodiment of the present invention, the thin film transistor array substrate may further comprise a plurality of common lines and a detection trace connected to one end of the common lines. The common lines are arranged on the substrate and the detection trace is arranged on the peripheral circuit region.

To achieve the above and other objects, the present invention provides a detection method suitable for the above mentioned liquid crystal display panel. The detection method comprises the following steps. First, a light source is provided and the liquid crystal display panel is arranged on the light source. A scan signal is transmitted to the scan lines through the inner anti-static rings. A data signal is transmitted to the data lines through the inner anti-static rings for displaying images on the liquid crystal display panel.

According to an embodiment of the present invention, after the scan signal and the data signal are transmitted, the liquid crystal display panel displays a black screen, a white screen or a gray level screen.

According to an embodiment of the present invention, after the scan signal and the data signal are transmitted, the liquid crystal display panel displays a red screen, a green screen or a blue screen.

To achieve the above and other objects, the present invention provides a thin film transistor array substrate comprising a substrate, a plurality of pixel units, a plurality of first lines, a plurality of second lines, an inner anti-static ring, a circuit, a plurality of first and second thin film transistors. The substrate comprises a display region and a peripheral circuit region around the display region. The pixel units are arranged on the display region. The first and second lines are arranged on the substrate, and the pixel units are controlled by the first lines and second lines. The inner anti-static ring, the circuit, the first and second thin film transistors are arranged on the peripheral circuit region. Each first thin film transistor comprises a gate, a source and a drain. The gates and the sources are connected to the inner anti-static ring, and the drains are connected to the first lines respectively. Each second thin film transistor comprises a gate, a source and a drain. The gates are connected to the inner anti-static ring, the sources are connected to the circuit, and the drains are connected to the second lines respectively.

According to an embodiment of the present invention, the above mentioned first lines may be scan lines and the second lines may be data lines.

According to an embodiment of the present invention, the above mentioned first lines may be data lines and the second lines may be scan lines.

According to an embodiment of the present invention, the circuit may comprise a plurality of lines, and the sources of the second thin film transistors are connected to the lines respectively.

According to an embodiment of the present invention, the thin film transistor array substrate may further comprise a plurality of detection pads arranged on the peripheral circuit region, and one end of the inner anti-static ring and the circuit are connected to one of the detection pads respectively.

According to an embodiment of the present invention, each pixel unit may comprise an active device and a pixel electrode. The active device is connected to one of the first lines and second lines, and the pixel electrode is connected to the active device.

According to an embodiment of the present invention, the thin film transistor array substrate may further comprise a plurality of common lines and a detection trace connected to one end of the common lines. The common lines are arranged on the substrate and the detection trace is arranged on the peripheral circuit region.

To achieve the above and other objects, the present invention provides a detection method suitable for the above mentioned thin film transistor array substrate. The detection method comprises the following steps. A current signal is transmitted to the first lines through the inner anti-static ring. Then, detection is performed on the circuit. If the current signal is detected, a short circuit occurs between the first lines and the second lines.

To achieve the above and other objects, the present invention provides a detection method suitable for the above mentioned thin film transistor array substrate. The detection method comprises the following steps. A current signal is transmitted to the first lines through the inner anti-static ring. Then, detection is performed on the lines. If the current signal is detected from the line, a short circuit occurs between the first lines and the second lines corresponding to the line.

To achieve the above and other objects, the present invention provides a detection method suitable for the above mentioned thin film transistor array substrate. The detection method comprises the following steps. A current signal is transmitted to the first lines through the inner anti-static ring. Then, detection is performed on the detection trace. If the current signal is detected, it means that a short circuit occurs between the first lines and the common lines.

According to an embodiment of the present invention, the mentioned first lines may be scan lines and the second lines may be data lines.

According to an embodiment of the present invention, the mentioned first lines may be data lines and the second lines may be scan lines.

To achieve the above and other objects, the present invention provides a liquid crystal display panel comprising a thin film transistor array substrate, a color filter substrate and a liquid crystal layer sandwiched between them. The thin film transistor array substrate comprises a substrate, a plurality of pixel units, a plurality of first lines and second lines, an inner anti-static ring, a circuit, a plurality of first and second thin film transistors. The substrate comprises a display region and a peripheral circuit region around the display region. The pixel units are arranged on the display region, and the first and second lines are arranged on the substrate. The pixel units are controlled by the first lines and second lines. The inner anti-static ring, the circuit, the first and second thin film transistors are arranged on the peripheral circuit region. Each first thin film transistor comprises a gate, a source and a drain. The gates and the sources are connected to the inner anti-static ring, and the drains are connected to the first lines respectively. Each second thin film transistor comprises a gate, a source and a drain. The gates are connected to the inner anti-static ring, the sources are connected to the circuit, and the drains are connected to the second lines respectively.

According to an embodiment of the present invention, the above mentioned first lines may be scan lines and the second lines may be data lines.

According to an embodiment of the present invention, the above mentioned first lines may be data lines and the second lines may be scan lines.

According to an embodiment of the present invention, the circuit comprises a plurality of lines. The sources of the second thin film transistors are connected to the lines respectively.

According to an embodiment of the present invention, the thin film transistor array substrate further comprises a plurality of detection pads arranged on the peripheral circuit region, and one end of the inner anti-static ring and the circuit are connected to one of the detection pads respectively.

According to an embodiment of the present invention, each pixel unit comprises an active device and a pixel electrode. The active device is connected to one of the first lines and second lines, and the pixel electrode is connected to the active device.

According to an embodiment of the present invention, the above mentioned thin film transistor array substrate further comprises a plurality of common lines and a detection trace connected to one end of the common lines. The common lines are arranged on the substrate and the detection trace is arranged on the peripheral circuit region.

To achieve the above and other objects, the present invention provides a detection method suitable for the above mentioned liquid crystal display panel. The detection method comprises the following steps. First, a light source is provided and the liquid crystal display panel is arranged on the light source. A first signal is transmitted to the first lines through the inner anti-static ring. A second signal is transmitted to the second lines through the circuit, to make the liquid crystal display panel display a black screen, a white screen or a gray level screen.

To achieve the above and other objects, the present invention provides a detection method suitable for the above mentioned liquid crystal display panel. The detection method comprises the following steps. First, a light source is provided and the liquid crystal display panel is arranged on the light source. A first signal is transmitted to the first lines through the inner anti-static ring. A second signal is transmitted to the second lines through the lines, to make the liquid crystal display panel display a red screen, a green screen or a blue level screen.

According to an embodiment of the present invention, the above mentioned first lines may be scan lines and the second lines may be data lines.

According to an embodiment of the present invention, the above mentioned first lines may be data lines and the second lines may be scan lines.

In summary, the invention takes the inner anti-static ring as a part or whole of the detection circuit, so the detection circuit and the ESD protection circuit can be integrated together. Besides, compared with the prior art, the invention has less detection pads and a simpler layout.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are schematic views showing a thin film transistor array substrate according to the first embodiment of the present invention.

FIG. 2 is a cross-sectional view showing a thin film transistor array substrate according to the first embodiment of the present invention.

FIG. 3 is a schematic view showing a thin film transistor array substrate according to the second embodiment of the present invention.

FIG. 4 is a schematic view showing a thin film transistor array substrate according to the third embodiment of the present invention.

FIG. 5 is a schematic view showing a thin film transistor array substrate according to the fourth embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

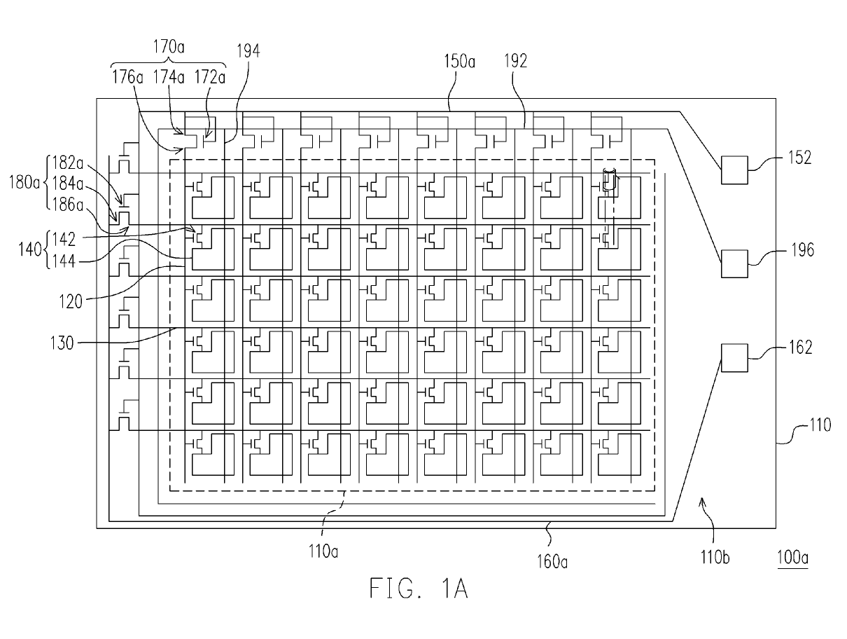

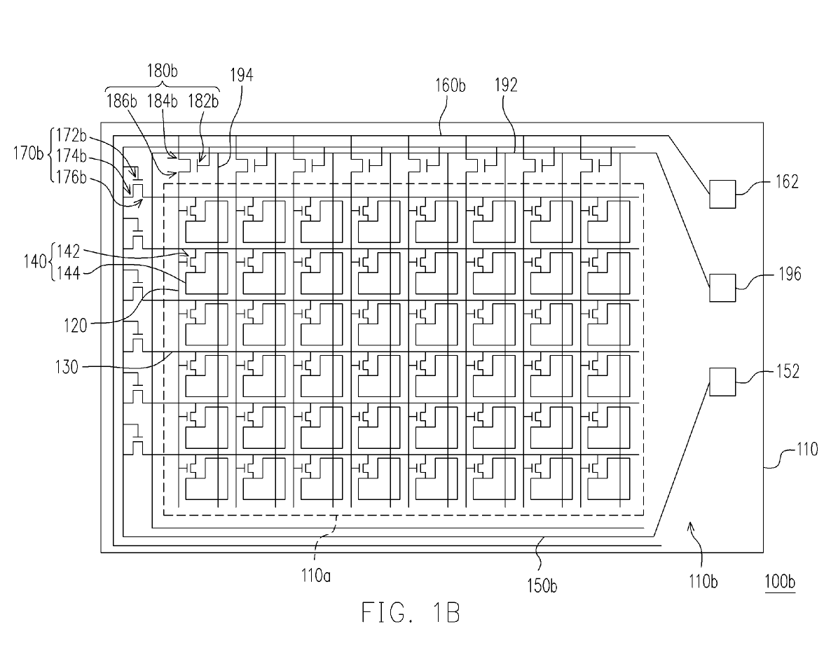

FIGS. 1A and 1B are schematic views showing a thin film transistor array substrate according to the first embodiment of the present invention. First, please refer to FIG. 1A, the thin film transistor array substrate 100a comprises a substrate 110, a plurality of scan lines 120, a plurality of data lines 130, a plurality of pixel units 140, an inner anti-static ring 150a, a circuit 160a, a plurality of first thin film transistors 170a and a plurality of second thin film transistors 180a. The substrate 110 comprises a display region 110a and a peripheral circuit region 110b. The substrate 110 may comprise a quartz substrate, a glass substrate or other transparent substrate.

The scan lines 120 and data lines 130 are arranged on the substrate 110, and the pixel units 140 are arranged on the display region 110a. Besides, each pixel unit 140 is controlled by the corresponding scan line 120 and data line 130. Further, each pixel unit 140 comprises an active device 142 and a pixel electrode 144. The active device 142 is connected to the corresponding scan line 120 and data line 130, and the pixel electrode 144 is connected to the active device 142. In this embodiment, the active device 142 is a thin film transistor. However, it can be a low temperature poly silicon thin film transistor (LTPS-TFT) or other active device.

The inner anti-static ring 150a, the circuit 160a, the first thin film transistors 170a and the second thin film transistors 180a are arranged on the peripheral circuit region 110b. The first thin film transistors 170a comprises a gate 172a, a source 174a and a drain 176a. The gate 172a and the source 174a are connected to the inner anti-static ring 150a, and the drain 176a is connected to the corresponding scan line 120. Besides, the second thin film transistor 180a comprises a gate 182a, a source 184a and a drain 186a. The gate 182a is connected to the inner anti-static ring 150a, the source 184a is connected to the circuit 160a, and the drain 186a is connected to the corresponding data line 130.

In this embodiment, the thin film transistor array substrate 100a may further comprise a detection trace 192 and a plurality of common lines 194. These common lines 194 are arranged on the substrate 110 and the detection trace 192 is arranged on the peripheral circuit region 110b. Besides, one end of each common line 194 is connected to the detection trace 192. In addition, the detection pads 152 and 162 can also be arranged at one end of the inner anti-static ring 150a and circuit 160a respectively. Similarly, the detection pad 196 can also be arranged at one end of the detection trace 192.

The gate 172a and the source 174a of the first thin film transistor 170a are connected to the inner anti-static ring 150a, and the gate 182a of the second thin film transistor 180a is connected to the inner anti-static ring 150a. So, when the electrostatic charges are conducted to the inner anti-static ring 150a, the first thin film transistor 170a and the second thin film transistor 180a can be turned on, and the electrostatic charges can be conducted to each scan line 120 through each first thin film transistor 170a. In other words, the inner anti-static ring 150a may conduct the electrostatic charges to the whole thin film transistor array substrate 100a, to avoid damaging the circuit resulted from the electrostatic charges. So, the first thin film transistor 170a, the second thin film transistor 180a and the inner anti-static ring 150a can be called the ESD protection circuit of the thin film transistor array substrate 100a. Besides, the first thin film transistor 170a and the second thin film transistor 180a can be called the ESD protection devices. It should be noted that the first thin film transistor 170a, the second thin film transistor 180a and the inner anti-static ring 150a can not also be the ESD protection circuit but also a detection circuit of the thin film transistor array substrate 100a.

The detection method suitable for the thin film transistor array substrate 100a comprises the following steps. First, a probe (not shown) touches the detection pad 152 to let a current signal be conducted to these scan lines 120 through the inner anti-static ring 150a. The voltage level of the current signal is the VGH for the first thin film transistor 170a and the second thin film transistor 180a. So, the current signal can travel through each first thin film transistor 170a to each scan lines 120. Then, let the probe touch the detection pad 162 in order to measure the circuit 160a. If a short circuit occurs between the scan lines 120 and the data lines 130, the current signal would be conducted to the drain 186a of the second thin film transistor 180a through the scan line 120 and data line 130. At this time, because the second thin film transistor 180a is turned on, the current signal would be conducted to the detection pad 162 through the circuit 160a. In other words, if the current signal is detected from the detection pad 162, it means that a short circuit occurs between the scan lines 120 and data lines 130.

Similarly, the above mentioned method is also suitable for detecting whether a short circuit occurs between the scan line 120 and the common line 194 or not. In brief, let the current signal be conducted to the scan lines 120 through the detection pad 152 and the inner anti-static ring 150a. If a short circuit occurs between the scan line 120 and the common line 194, the current signal would be conducted to the detection pad 196 through the scan line 120, the common line 192 and the detection trace 192 sequentially. So, the inspector may determine whether a short circuit occurs between the scan lines 120 and the common lines 194 according to the measurement of the current signal.

Because the inner anti-static ring 150a, the first thin film transistor 170a and the second thin film transistor 180a can be a part of the detection circuit, the thin film transistor array substrate 100a has more areas for the layout compared with the prior art. Besides, the circuit for detecting the thin film transistor array substrate 100a can be simplified and the detection time is shorter, to improve the production efficiency. Further, the number of the detection pads can be reduced. It should be noted that the above mentioned first thin film transistor 170a is connected to the scan line 120 and the second thin film transistor 180a is connected to the data line 130, but the connection manner can be reversed as the following.

Please refer to FIG. 1B, in the thin film transistor array substrate 100b, the gate 172b and the source 174b of the first thin film transistor 170b are connected to the inner anti-static ring 150b, and the drain 176b of the first thin film transistor 170b is connected to the data line 130. Besides, the gate 182b of the second thin film transistor 180b is also connected to the inner anti-static ring 150b, and the source 184b of the second thin film transistor 180b is also connected to the circuit 160b. In addition, the drain 186b of the second thin film transistor 180b is connected to the scan line 120.

Similarly, the detection method suitable for the thin film transistor array substrate 100b comprises the following steps. First, a current signal is transmitted to the data lines 130 through the detection pad 152 and the inner anti-static ring 150b. Because the voltage level of the current signal is the VGH for the first thin film transistor 170b and the second thin film transistor 180b. So, the current signal can travel through each first thin film transistor 170b to each data lines 130. If a short circuit occurs between the data lines 130 and the scan lines 120, the current signal would be conducted to the detection pad 162 through the data line 130, scan line 120 and the circuit 160b. However, the same method can also apply to determine whether a short circuit occurs between the data line 130 and the common line 194 or not. In brief, a current signal is transmitted to the detection pad 152, then, the detection pad 196 is detected to see if the current signal is detected therefrom in order to determine whether a short circuit occurs between the data line 130 and the common line 194 or not. It should be noted that after the panel is fabricated, a testing should also be performed on the panel, and the testing taken the above mentioned thin film transistor array substrate 100a as an example is interpreted in the following.

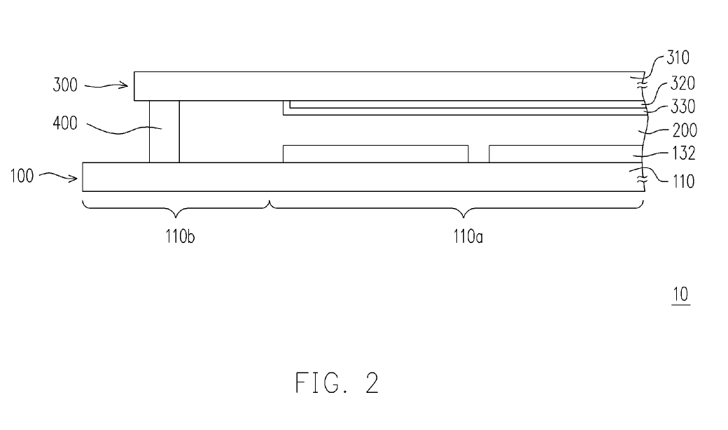

FIG. 2 is a cross-sectional view showing a thin film transistor array substrate according to the first embodiment of the present invention. FIG. 2 only shows the necessary elements in order to simplify the drawing. Please refer to FIG. 1A and FIG. 2, the liquid crystal display panel 10 comprises a thin film transistor array substrate 100a, a liquid crystal layer 200 and a color filter substrate 300. The color filter substrate 300 attaches the thin film transistor array substrate 100a by a sealant 400. Besides, the liquid crystal layer 200 is arranged in a closed space constructed by the color filter substrate 300, the thin film transistor array substrate 100a and the sealant 400. Besides, the color filter substrate 300 comprises a substrate 310, a color filter layer 320 and a common electrode layer 330. The color filter layer 320 is sandwiched between the substrate 310 and the common electrode layer 330, and the common electrode layer 330 faces the thin film transistor array substrate 100a.

The detection method apply to the above mentioned liquid crystal display panel 10 comprises the following steps. First, the liquid crystal display panel 10 is arranged on a light source (not shown). A scan signal is transmitted to the scan lines 120 through the detection pad 152, the inner anti-static ring 150a and the first transistors 170a. A data signal is transmitted to the data lines 130 through the detection pad 152, the circuit 160a and the second transistors 180a for displaying a black screen, a white screen or a gray level screen on the liquid crystal display panel 10. Besides, the above mentioned scan signal and data signal can be separately transmitted to the scan lines 120 and data lines 130 at the same time. It should be noted that when the liquid crystal display panel 10 operates, a turn-off voltage level of the first transistors 170a and the second transistors 180a can be transmitted to the inner anti-static ring 150a in order to avoid signal interference.

Similarly, the above mentioned method can also apply to the thin film transistor array substrate 100b as a part of the liquid crystal display panel 10. In details, a data signal is transmitted to the data lines 130 through the detection pad 152, the inner anti-static ring 150b and the first transistors 170a. A scan signal is transmitted to the scan lines 130 through the detection pad 162, the circuit 160b and the second transistors 180b for displaying a black screen, a white screen or a gray level screen on the liquid crystal display panel 10. It should be noted that the data signal should overlap the scan signal.

### Second Embodiment

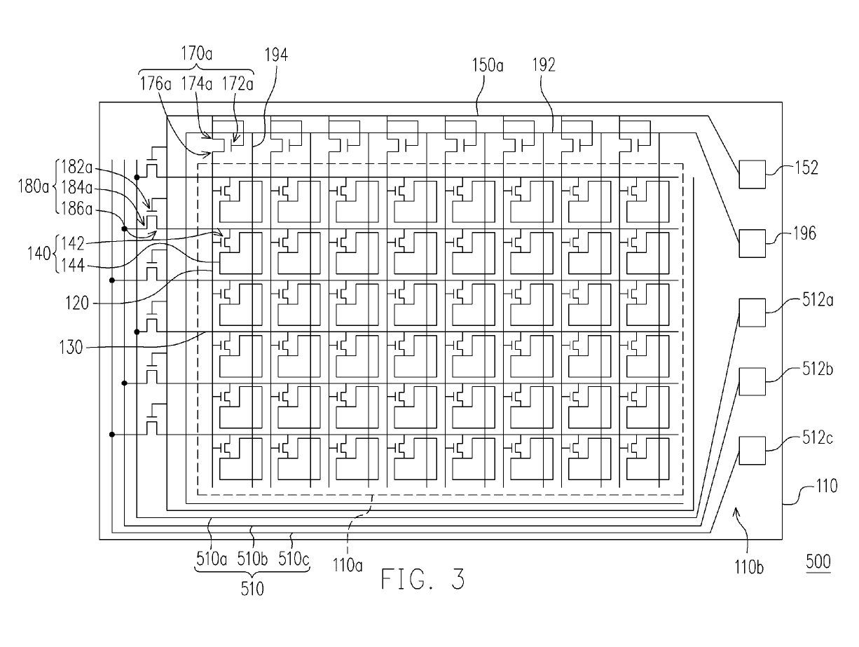

FIG. 3 is a schematic view showing a thin film transistor array substrate according to the second embodiment of the present invention. Please refer to FIG. 3, the content of FIG. 3 is similar to that of FIG. 1, the difference is that the circuit 510 of the thin film transistor array substrate 500 comprises lines 510a, 510b and 510c. Besides, the detection pad 512a, 512b and 512c can be arranged at one end of the lines 510a, 510b and 510c in order to input signals or measure signals.

For a short circuit detection, the detection method for the thin film transistor array substrate 500 comprises the step of transmitting current signals to the scan lines 120 through the detection pad 152, the inner anti-static ring 150a and the first transistors 170a. Then, each detection pad 512a, 512b and 512c is measured respectively in order to determine that a short circuit occurs between the scan lines 120 and data lines 130 connected to the detection pad 512a, 512b and 512c. For example, if a current signal is measured from the detection pad 512a, it means that a short circuit occurs between the scan line 120 and data line 130 connected to the detection pad 512a. Similarly, the above mentioned method can also apply to determine that if a short circuit occurs between the common line 194 and the data line 130 connected to each detection pad 512a, 512b and 5 2c.

If the thin film transistor array substrate 500 has been fabricated to become a panel (similar to FIG. 2), the detection method may comprise the step of transmitting a scan signal to the scan lines 120 through the detection pad 152, the inner anti-static ring 150a and the first transistors 170a. The data signals indicating red, green and blue are transmitted to the data lines 130 through the corresponding lines 510a, 510b and 510c. In order words, compared to FIG. 2, the embodiment can detect red, green or blue screen respectively.

Similarly, the circuit 160b shown in FIG. 1B can be divided into two kinds of lines connected to the odd and even scan lines 120, to determine that if a short circuit occurs between the data line 130 and the odd or even scan lines 120. Similarly, the above mentioned detection method can also apply to determine that if a short circuit occurs between the common line 194 and the odd or even scan lines 120. Besides, the above mentioned detection method can also apply to the liquid crystal display panel comprising this type of thin film transistor array substrate.

### Third Embodiment

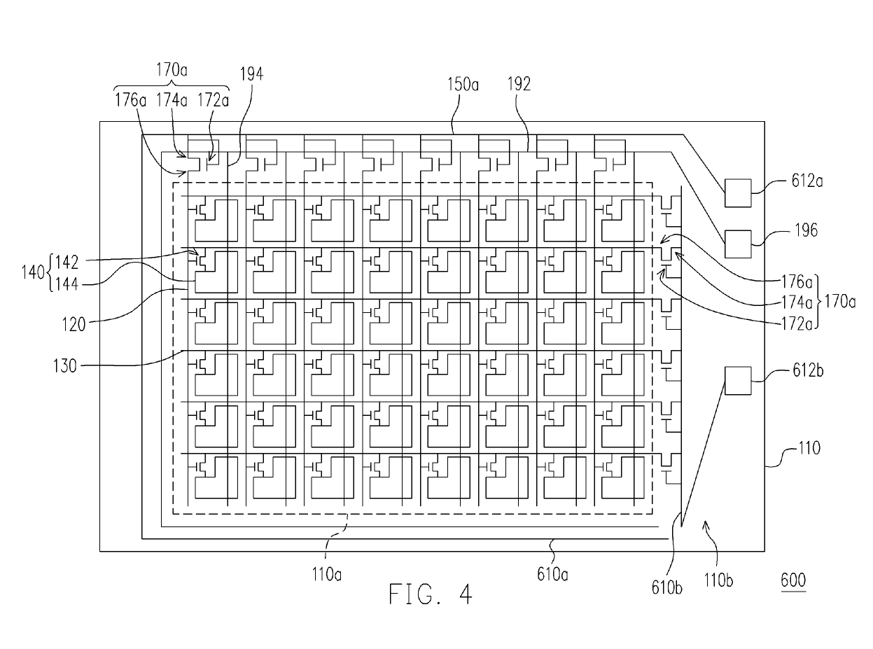

FIG. 4 is a schematic view showing a thin film transistor array substrate according to the third embodiment of the present invention. Please refer to FIG. 4, the content of FIG. 4 is similar to that of FIG. 1, the difference is that a portion of the first transistors 170a of the thin film transistor array substrate 600 are connected to the inner anti-static ring 610a and the scan line 120 respectively and the other portion of the first transistors 170a are connected to the inner anti-static ring 610b and the data line 130. In other words, the thin film transistor array substrate 600 doesn't comprise a circuit similar to the circuit 160a shown in FIG. 1A. Besides, the detection pads 612a and 612b can also be arranged at one end of the inner anti-static rings 610a and 610b.

Similarly, the above mentioned detection method can also apply to determine that if a short circuit occurs between the common line 194 and the scan line 120. In brief, a current signal is transmitted to the scan line 120 through the detection pad 612a, the inner anti-static rings 610a and the first transistor 170a. Then, the detection pad 196 is detected. If the input current signal is measured, it means that a short circuit occurs between the scan line 120 and the common line 194. Similarly, the same method can also apply to detect if a short circuit occurs between the common line 194 and the data line 130.

If the thin film transistor array substrate 600 has been fabricated to become a panel (similar to FIG. 2), the detection method may comprise the step of transmitting the scan signal and the data signal to the scan lines 120 and data lines 130 through the inner anti-static ring 610a and 610b, to perform the white screen, black screen or gray level screen detection.

### Fourth Embodiment

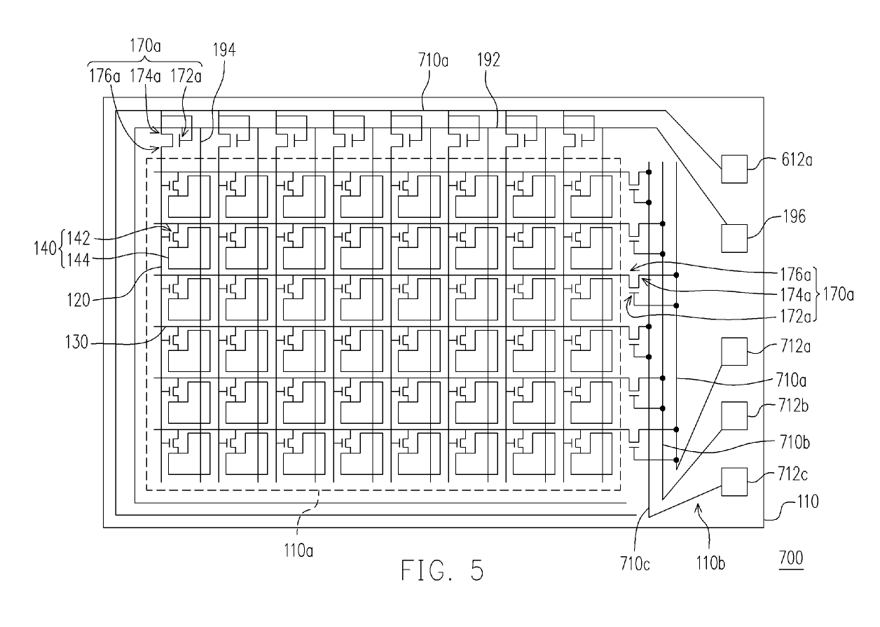

FIG. 5 is a schematic view showing a thin film transistor array substrate according to the fourth embodiment of the present invention. Please refer to FIG. 5, the content of FIG. 4 is similar to that of FIG. 1, the difference is that the data line 120 corresponding to red, green and blue are connected to the inner anti-static ring 710a, 710b and 710c respectively. Besides, the detection pads 712a, 712b and 712c are arranged at one end of the inner anti-static ring 710a, 710b and 710c respectively.

For the short circuit detection, it can detect that if a short circuit occurs between the data lines 120 corresponding to red, green and blue and the common line 192. Similarly, it can also detect that if a short circuit occurs between the common line 192 and the scan line 120.

If the thin film transistor array substrate 700 has been fabricated to become a panel (similar to FIG. 2), the detection method may comprise the step of transmitting the scan signal to the scan lines 120 through the inner anti-static ring 610a, then the data signal is transmitted to the data lines 130 through the inner anti-static rings 710a, 710b and 710c, to perform the red screen, green screen or blue screen detection.

Similarly, the scan lines 120 can be divided into the odd and even scan lines 120, and the odd and even scan lines 120 are connected to the inner anti-static rings (not shown) which are electrical isolated with each other. Besides, in this arrangement, a short circuit occurs between the odd scan lines 120 and the common lines 192 can also be detected. Alternatively, a short circuit occurs between the even scan lines 120 and the common lines 192 can also be detected. The white screen, black screen or gray level screen detection can also be performed on the liquid crystal display panel having the thin film transistor array substrate. Alternatively, the red screen, green screen or blue screen detection can also be performed on the liquid crystal display panel.

In summary, the invention has the following advantages:

1. Compared with the prior art, the invention takes the inner anti-static ring as a part of the detection circuit or whole circuit so the layout area of the substrate increases and the complexity of the layout is lower. In other words, the invention integrates the detection circuit with the ESD protection circuit.

2. After the panel operates, the turn-off voltage level for transistor can be transmitted to the inner anti-static ring, to avoid signal interference.

3. With different arrangement of the inner anti-static ring, the invention can detect that if a short circuit occurs between the scan line and the common line, the data line and the common line or the scan line and the data line.

4. After the panel is fabricated, the black screen, the white screen or the gray level screen detection can be performed on the panel. Alternatively, the red screen, the green screen or the blue screen detection can be performed on the panel.

5. Compared with the prior art, the detection time of the present invention is shorter.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thin film transistor array substrate, comprising:
a substrate comprising a display region and a peripheral circuit region around the display region;
a plurality of pixel units arranged on the display region;
a plurality of scan lines arranged on the substrate;
a plurality of data lines arranged on the substrate, wherein the pixel units are controlled by the scan line and data line;
a plurality of inner anti-static rings arranged on the peripheral circuit region;
a plurality of first thin film transistors arranged on the peripheral circuit region, each first thin film transistor comprising a gate, a source and a drain, wherein the gates and the sources are connected to one part of the inner anti-static rings, and the drains are connected to the scan lines respectively; and
a plurality of second thin film transistors arranged on the peripheral circuit region, each second thin film transistor comprising a gate, a source and a drain, wherein the gates and the sources are connected to the other part of the inner anti-static rings, and the drains are connected to the data lines respectively.

2. The thin film transistor array substrate according to claim 1, further comprising a plurality of detection pads arranged on the peripheral circuit region, wherein one end of each inner anti-static ring is connected to one of the detection pad.

3. The thin film transistor array substrate according to claim 1, wherein each pixel unit comprises:
an active device connected to one of the scan lines and data lines; and
a pixel electrode connected to the active device.

4. The thin film transistor array substrate according to claim 1, further comprising a plurality of common lines and a detection trace connected to one end of each common lines, wherein the common lines are arranged on the substrate and the detection trace is arranged on the peripheral circuit region.

5. A liquid crystal display panel, comprising:
a thin film transistor array substrate comprising:
a substrate comprising a display region and a peripheral circuit region around the display region;
a plurality of pixel units arranged on the display region;
a plurality of scan lines arranged on the substrate;
a plurality of data lines arranged on the substrate, wherein the pixel units are controlled by the scan lines and data lines;
a plurality of inner anti-static rings arranged on the peripheral circuit region;
a plurality of first thin film transistors arranged on the peripheral circuit region, each first thin film transistor comprising a gate, a source and a drain, wherein the gates and the sources are connected to one part of the inner anti-static rings, and the drains are connected to the corresponding scan lines respectively; and
a plurality of second thin film transistors arranged on the peripheral circuit region, each second thin film transistor comprising a gate, a source and a drain, wherein the gates and the sources are connected to the other part of the inner anti-static rings, and the drains are connected to the data lines respectively;
a color filter substrate; and
a liquid crystal layer sandwiched between the color filter substrate and the thin film transistor array substrate.

6. The liquid crystal display panel according to claim 5, wherein the thin film transistor array substrate further comprises a plurality of detection pads arranged on the peripheral circuit region, and one end of each inner anti-static ring is connected to one of the detection pads.

7. The liquid crystal display panel according to claim 5, wherein each pixel unit comprises:
an active device connected to one of the scan lines and data lines; and
a pixel electrode connected to the active device.

8. The liquid crystal display panel according to claim 5, wherein the thin film transistor array substrate further comprises a plurality of common lines and a detection trace connected to one end of the common lines, wherein the common lines are arranged on the substrate and the detection trace is arranged on the peripheral circuit region.

9. A detection method for the liquid crystal display panel as recited in claim 5, the detection method comprising the following steps:
providing a light source and arranging the liquid crystal display panel on the light source;
transmitting a scan signal to the scan lines through the inner anti-static rings; and
transmitting a data signal to the data lines through the inner anti-static rings for displaying images on the liquid crystal display panel.

10. The detection method according to claim 9, wherein after the scan signal and the data signal are transmitted, the liquid crystal display panel displays a black screen, a white screen or a gray level screen.

11. The detection method according to claim 9, wherein after the scan signal and the data signal are transmitted, the liquid crystal display panel displays a red screen, a green screen or a blue screen.

12. A thin film transistor array substrate, comprising:
a substrate comprising a display region and a peripheral circuit region around the display region;
a plurality of pixel units arranged on the display region;
a plurality of first lines arranged on the substrate;
a plurality of second lines arranged on the substrate, wherein the pixel units are controlled by the first lines and second lines;
an inner anti-static ring arranged on the peripheral circuit region;
a circuit arranged on the peripheral circuit region;
a plurality of first thin film transistors arranged on the peripheral circuit region, each first thin film transistor comprising a gate, a source and a drain, wherein the gates and the sources are connected to the inner anti-static ring, and the drains are connected to the first lines respectively; and
a plurality of second thin film transistors arranged on the peripheral circuit region, each second thin film transistor comprising a gate, a source and a drain, wherein the gates are connected to the inner anti-static ring, the sources are connected to the circuit, and the drains are connected to the second lines respectively.

13. The thin film transistor array substrate according to claim 12, wherein the first lines are scan lines and the second lines are data lines.

14. The thin film transistor array substrate according to claim 12, wherein the first lines are data lines and the second lines are scan lines.

15. The thin film transistor array substrate according to claim 12, wherein the circuit comprises a plurality of lines, and the sources of the second thin film transistors are connected to the lines respectively.

16. The thin film transistor array substrate according to claim 12, further comprising a plurality of detection pads arranged on the peripheral circuit region, one end of the inner anti-static ring and the circuit being connected to one of the detection pads respectively.

17. The thin film transistor array substrate according to claim 12, wherein each pixel unit comprises:
an active device connected to one of the first lines and second lines; and
a pixel electrode connected to the active device.

18. The thin film transistor array substrate according to claim 12, further comprising a plurality of common lines and a detection trace connected to one end of the common lines, wherein the common lines are arranged on the substrate and the detection trace is arranged on the peripheral circuit region.

19. A detection method for the thin film transistor array substrate as recited in claim 12, the detection method comprising the following steps:
transmitting a current signal to the first lines through the inner anti-static ring; and
detecting the circuit, if the current signal is detected, a short circuit occurs between the first lines and the second lines.

20. The detection method according to claim 19, wherein the first lines are scan lines and the second lines are data lines.

21. The detection method according to claim 19, wherein the first lines are data lines and the second lines are scan lines.

22. A detection method for the thin film transistor array substrate as recited in claim 15, the detection method comprising the following steps:
transmitting a current signal to the first lines through the inner anti-static ring; and
detecting the lines, if the current signal is detected from the line, a short circuit occurs between the first lines and the second lines corresponding to the line.

23. The detection method according to claim 22, wherein the first lines are scan lines and the second lines are data lines.

24. The detection method according to claim 22, wherein the first lines are data lines and the second lines are scan lines.

25. A detection method for the thin film transistor array substrate as recited in claim 18, the detection method comprising the following steps: transmitting a current signal to the first lines through the inner anti-static ring; and detecting the detection trace, if the current signal is detected, a short circuit occurs between the first lines and the common lines.

26. The detection method according to claim 25, wherein the first lines are scan lines and the second lines are data lines.

27. The detection method according to claim 25, wherein the first lines are data lines and the second lines are scan lines.

28. A liquid crystal display panel, comprising:
a thin film transistor array substrate comprising:
a substrate comprising a display region and a peripheral circuit region around the display region;
a plurality of pixel units arranged on the display region;
a plurality of first lines arranged on the substrate;
a plurality of second lines arranged on the substrate, wherein the pixel units are controlled by the first lines and second lines;
an inner anti-static ring arranged on the peripheral circuit region;
a circuit arranged on the peripheral circuit region;
a plurality of first thin film transistors arranged on the peripheral circuit region, each first thin film transistor comprising a gate, a source and a drain, wherein the gates and the sources are connected to the inner anti-static ring, and the drains are connected to the first lines respectively; and
a plurality of second thin film transistors arranged on the peripheral circuit region, each second thin film transistor comprising a gate, a source and a drain, wherein the gates are connected to the inner anti-static ring, the sources are connected to the circuit, and the drains are connected to the second lines respectively;
a color filter substrate; and
a liquid crystal layer sandwiched between the color filter substrate and the thin film transistor array substrate.

29. The liquid crystal display panel according to claim 28, wherein the first lines are scan lines and the second lines are data lines.

30. The liquid crystal display panel according to claim 28, wherein the first lines are data lines and the second lines are scan lines.

31. The liquid crystal display panel according to claim 28, wherein the circuit comprises a plurality of lines and the sources of the second thin film transistors are connected to the lines respectively.

32. The liquid crystal display panel according to claim 28, wherein the thin film transistor array substrate further comprises a plurality of detection pads arranged on the peripheral circuit region, and one end of the inner anti-static ring and the circuit are connected to one of the detection pads respectively.

33. The liquid crystal display panel according to claim 28, wherein each pixel unit comprises:
an active device connected to one of the first lines and second lines; and
a pixel electrode connected to the active device.

34. The liquid crystal display panel according to claim 28, wherein the thin film transistor array substrate further comprises a plurality of common lines and a detection trace connected to one end of the common lines, the common lines are arranged on the substrate and the detection trace is arranged on the peripheral circuit region.

35. A detection method for the liquid crystal display panel as recited in claim 28, the detection method comprising the following steps:
providing a light source and arranging the liquid crystal display panel on the light source;
transmitting a first signal to the first lines through the inner anti-static ring; and
transmitting a second signal to the second lines through the circuit to make the liquid crystal display panel display a black screen, a white screen or a gray level screen.

36. The detection method according to claim 35, wherein the first lines are scan lines and the second lines are data lines.

37. The detection method according to claim 35, wherein the first lines are data lines and the second lines are scan lines.

38. A detection method for the liquid crystal display panel as recited in claim 31, the detection method comprising the following steps:
providing a light source and arranging the liquid crystal display panel on the light source;
transmitting a first signal to the first lines through the inner anti-static ring; and
transmitting a second signal to the second lines through the lines to make the liquid crystal display panel display a red screen, a green screen or a blue screen.

39. The detection method according to claim 38, wherein the first lines are scan lines and the second lines are data lines.

40. The detection method according to claim 38, wherein the first lines are data lines and the second lines are scan lines.
